(19) United States
(12) Patent Application Publication
(10) Pub. No.: US 2009/0016179 A1
(43) Pub. Date: Jan. 15, 2009

(54) NEAR-FIELD OPTICAL DISK APPARATUS AND FOCUS PULL-IN METHOD

(75) Inventors: An-sik Jeong, Hwaseong-si (KR); Jong-hyun Shin, Suwon-si (KR); Jin-kyung Lee, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co.,Ltd., Suwon-si (KR)

(21) Appl. No.: 11/961,120

(22) Filed: Dec. 20, 2007

(30) Foreign Application Priority Data
Jul. 9, 2007 (KR) 2007-68803

(51) Int. Cl. G11B 7/00

(52) U.S. Cl. 369/44.23

(57) ABSTRACT

A near-field optical disk apparatus, which can perform stable focus pull-in even when overshoot occurs, and a focus pull-in method, of which the method includes: raising an actuator, and monitoring and determining whether light focused on a disk is near-field light; holding or storing a driving voltage of the actuator if the light focused on the disk is the near-field light; raising the actuator, and determining a maximum driving voltage of the actuator; and performing focus pull-in while lowering the actuator in an interval where a driving voltage of the actuator is between the maximum driving voltage and the held or stored driving voltage.

### CROSS-REFERENCE TO RELATED APPLICATION

This application claims the benefit of Korean Patent Application No. 2007-68803, filed on Jul. 9, 2007, in the Korean Intellectual Property Office, the disclosure of which is incorporated herein by reference.

### BACKGROUND OF THE INVENTION

1. Field of the Invention

Aspects of the present invention relate to a near-field optical disk apparatus and a focus pull-in method, and more particularly, to a near-field optical disk apparatus, which can perform stable focus pull-in, and a focus pull-in method.

2. Description of the Related Art

Recently, near-field optical disk apparatuses have been suggested to achieve a high storage capacity and a high data transfer rate. Such near-field optical disk apparatuses are called near-field recording systems. Near-field optical disk apparatuses record or reproduce data on a disk using light in a near-field where no diffraction of the light occurs. Accordingly, a gap distance between an optical disk and an end surface of a solid immersion lens (SIL) installed in a light focusing element, such as an objective lens, of a near-field optical disk apparatus must be controlled to be within several nanometers (nm). In general, the gap distance is half the wavelength of input laser light. For example, when a violet laser beam having a wavelength of 400 nm is used, the gap distance is approximately 200 nm.

In such a near-field optical disk apparatus, when an actuator is raised to a near-field level, an optical disk absorbs part of the incident light, thereby reducing reflected light intensity and lowering a gap error signal. When the level of the gap error signal falls to a target point, the near-field optical disk apparatus performs focus pull-in, which is also called gap pull-in because a focus servo operation in the near-field optical disk apparatus may include a gap servo operation.

However, since the gap distance is as small as several nanometers as described above, when overshoot occurs during the focus pull-in, an SIL may collide with the optical disk. The overshoot may occur when the dynamic characteristics of the actuator are reduced or the SIL is contaminated.

### SUMMARY OF THE INVENTION

Aspects of the present invention provide a near-field optical disk apparatus, which can perform stable focus pull-in even when overshoot occurs, and a focus pull-in method.

According to an aspect of the present invention, there is provided a focus pull-in method comprising: raising an actuator, and monitoring and determining whether light focused on a disk is near-field light; holding or storing a driving voltage of the actuator if the light focused on the disk is the near-field light; raising the actuator to determine a maximum driving voltage of the actuator; and performing focus pull-in while lowering the actuator through an interval in which a driving voltage of the actuator is between the maximum driving voltage and the held or stored driving voltage.

According to an aspect of the present invention, the monitoring and determining of whether the light focused on the disk is the near-field light may be performed based on a gap error signal.

According to an aspect of the present invention, the focus pull-in method may further comprise stopping the operation of the actuator, when the holding or storing of the driving voltage of the actuator is performed.

According to an aspect of the present invention, the maximum driving voltage may be k times the held or stored driving voltage, and the k may be a preset value based on a gap distance between a lens included in a light focusing element moved by the actuator and the disk and/or the driving voltage characteristics of the actuator.

According to an aspect of the present invention, the determining of the maximum driving voltage of the actuator may comprise monitoring a gap error signal and a driving voltage for the actuator, raising the actuator to an emergency level, and determining the maximum driving voltage, and the focus pull-in method may further comprise holding or storing the maximum driving voltage. The emergency level may be a contact level at which a lens included in a light focusing element and the disk contact each other, or a level near to the contact level.

According to another aspect of the present invention, there is provided a near-field optical disk apparatus comprising: a light focusing element to focus light emitted from a light source on a disk; an actuator to raise and lower the light focusing element in a direction perpendicular to the disk according to a driving voltage of the actuator; a light intensity detector to detect the intensity of light returned from the light focusing element; a servo module to produce a gap error signal and a driving voltage for the actuator based on the intensity of light detected by the light intensity detector, and to provide the driving voltage to the actuator; and a control module to control the servo module to perform focus pull-in during lowering of the actuator when lowering the actuator after raising the actuator using the driving voltage and the gap error signal.

According to an aspect of the current invention, the control module may: monitor and determine whether light focused on the disk is near-field light while raising the actuator from a far-field toward the disk; hold or store a driving voltage of the actuator, if it is determined that the light focused on the disk is the near-field light; determine a maximum driving voltage of the actuator when raising the actuator; and perform the focus pull-in while the lowering the actuator through an interval in which the driving voltage of the actuator is between the maximum driving voltage and the held or stored driving voltage.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a near-field optical disk apparatus according to an embodiment of the present invention;

FIG. 2 is a graph illustrating a gap error signal produced when an actuator of the near-field optical disk apparatus of FIG. 1 is raised;

FIGS. 3A, 3B, and 3C illustrate an example of focus pull-in performed by the near-field optical disk apparatus of FIG. 1;

FIGS. 4A, 4B, and 4C illustrate another example of focus pull-in performed by the near-field optical disk apparatus of FIG. 1;

FIG. 5 is a flowchart illustrating a focus pull-in method according to an embodiment of the present invention; and

FIG. 6 is a flowchart illustrating a focus pull-in method according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

A near-field optical disk apparatus and a focus pull-in method according to aspects of the present invention perform focus pull-in when lowering an actuator, which was raised, to prevent collisions between a solid immersion lens (SIL) installed in a light focusing element and an optical disk due to overshoot during the focus pull-in. In particular, the near-field optical disk apparatus and the focus pull-in method according to aspects of the present invention can control a focus pull-in interval using a driving voltage of the actuator or a maximum driving voltage of the actuator when the actuator is raised and light emitted from a light source is detected as near-field light, or a driving voltage of the actuator when the actuator is raised to an emergency level or a contact level, wherein the contact level is a level at which the SIL and the optical disk contact each other.

FIG. 1 is a block diagram of a near-field optical disk apparatus 100 according to an embodiment of the present invention. Referring to FIG. 1, the near-field optical disk apparatus 100 includes an optical head 110, a servo module 120, a control module 130, and a storage unit 140. The optical head 110 includes a light source 111, a light processor 112, a light focusing element 113 including an SIL 114, an actuator 115, and a light intensity detector 116.

The light source 111 may be a laser diode that emits light when the light source 111 is turned on by the servo module 120. The light processor 112 transmits light emitted from the light source 111 to the light focusing element 113, and transmits light reflected from the light focusing element 113 to the light intensity detector 116. To this end, the light processor 112 may include a collimator lens, an anamorphic prism, a beam splitter, a wave plate, an achromatic lens, an extension lens, a wollaston prism, and/or a condenser lens.

The light focusing element 113 is configured so that the SIL 114 faces a disk 101. The light focusing element 113 focuses light incident from the light processor 112 on the disk 101 as near-field light via the SIL 114 to write data on the disk 101 or read data from the disk 101. Light reflected or diffracted by the disk 101 is received by the light focusing element 113 via the SIL 114 and then the light is transmitted to the light processor 112.

When a driving voltage is applied, the actuator 115 is raised or lowered to raise or lower the light focusing element 113 in a direction perpendicular to the disk 101. Accordingly, when the actuator 115 is raised in the direction perpendicular to the disk 101, the light focusing element 113 gets closer to the disk 101, and when the actuator 115 is lowered in the direction perpendicular to the disk 101, the light focusing element 113 gets further away from the disk 101.

The light intensity detector 116 detects the intensity of light reflected or diffracted from the light processor 112, wherein the light intensity detector 116 may be a photodetector. The detected intensity of light may be referred to as the intensity of totally reflected returned light. The detected intensity of light is transmitted to the servo module 120.

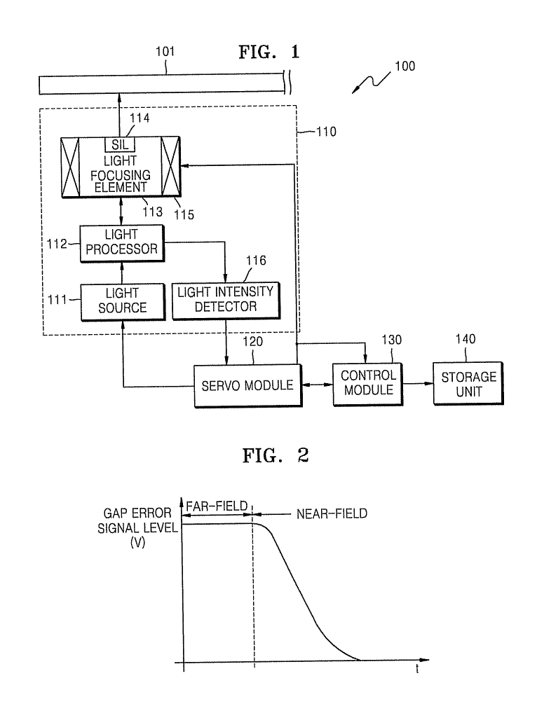

The servo module 120 produces a gap error signal and a driving voltage for the actuator 115 according to the intensity of light returned from the light intensity detector 116. The servo module 120 provides the driving voltage to the actuator 115 and the control module 130 and provides the gap error signal to the control module 130. The voltage level of the gap error signal produced by the servo module 120 approaches zero (0) volts as the SIL 114 included in the light focusing element 113 gets closer to the disk 101 as shown in FIG. 2.

Referring to and as shown in FIG. 2, the voltage level of the gap error signal produced by the servo module 120 in a far-field is maintained constant, and the voltage level of the gap error signal produced by the servo module 120 in a near-field where the SIL 114 is close to the disk 101 is decreased. When the SIL 114 contacts the disk 101, the voltage level of the gap error signal approaches zero (0) volts because the disk 101 absorbs part of light incident from the SIL 114 to reduce the intensity of light reflected from the disk 101. Accordingly, the servo module 120 can drive the actuator 115 so that the gap error signal approaches zero (0) volts in the near-field. FIG. 2 is a graph illustrating a gap error signal produced by the servo module 120 when the actuator 115 is raised from a lowered level so that the light focusing element 113 gets closer to the disk 101. The servo module 120 may adjust a gain and offset of the gap error signal.

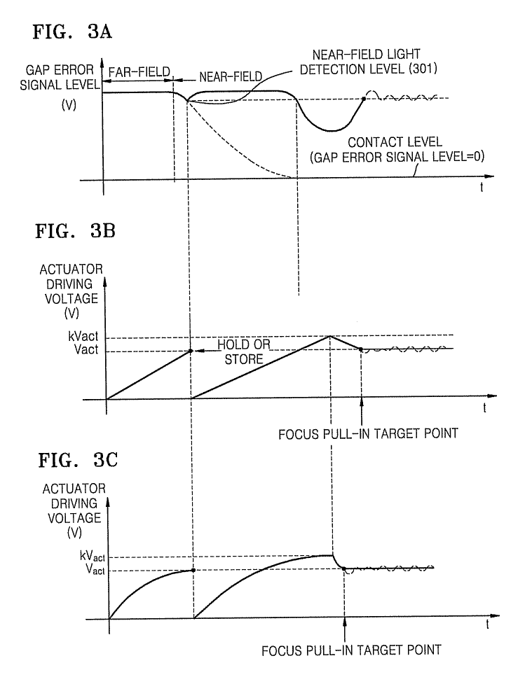

The control module 130 controls the servo module 120 to perform focus pull-in in an interval where the actuator 115, which was raised, is lowered. That is, when the light focusing element 113 starts to approach the disk 101, the control module 130 controls the servo module 120 to raise the actuator 115 such that the servo module 120 turns on the light source 111 and transmits a driving voltage to the actuator 115, and the servo module 120 provides a gap error signal based on the intensity of light returned from the light intensity detector 116 to the control module 130. When the voltage level of the gap error signal is decreased to a near-field light detection level 301 of FIG. 3A, the control module 130 holds or stores a driving voltage Vact (see FIG. 3B) of the actuator 115 in the storage unit 140. At this time, the control module 130 stops the operation of the actuator 115. The holding of the driving voltage Vact means that the driving voltage of the actuator 115 is temporarily possessed by the control module 130.

Then, the control module 130 multiplies the held or stored driving voltage of the actuator 115 by a preset parameter k to determine a maximum driving voltage of the actuator 115. That is, a driving voltage k×Vact, or kVact, obtained by multiplying the held or stored driving voltage Vact of the actuator 115 by the preset k is determined as the maximum driving voltage of the actuator 115. The k may be determined depending on a gap distance between the light focusing element 113 and the disk 101 in a near-field and the driving voltage characteristics of the actuator 115 in the near-field. A driving voltage of the actuator 115 in a near-field may vary linearly as shown in FIG. 3B or exponentially as shown in FIG. 3C. FIGS. 3A, 3B, and 3C illustrate an example of focus pull-in performed by the near-field optical disk apparatus 100.

The control module 130 controls the servo module 120 to raise the actuator 115 until the voltage level of a driving voltage of the actuator 115 becomes the maximum driving voltage kVact, and then performs a focus pull-in at a focus pull-in target point between the held or stored driving voltage Vact and the maximum driving voltage kVact when lowering the actuator 115. In FIGS. 3B and 3C, a point at which a driving voltage of the actuator 115, which is lowered, becomes the held or stored actuator driving voltage Vact is determined as a focus pull-in target point. As a result, since focus pull-in is performed as the actuator 115 moves in a far-field direction, i.e., when the actuator 115 is lowered, overshoot occurs in the far-field direction, thereby preventing collisions between the disk 101 and the SIL 114 installed in the light focusing element 113.

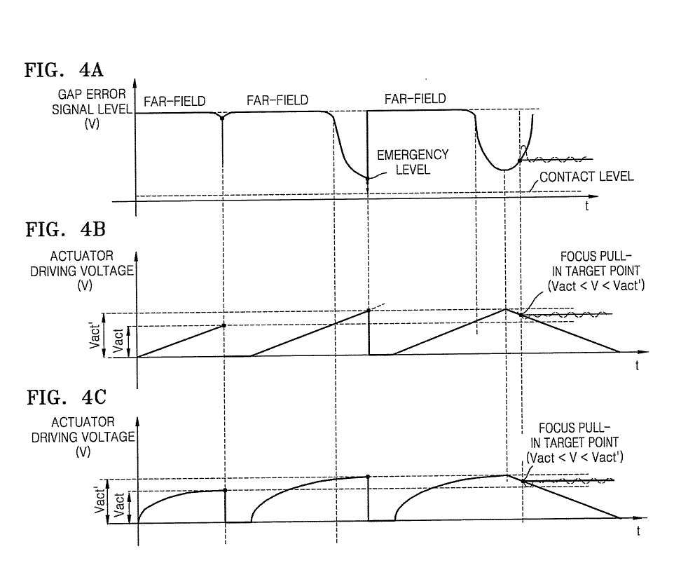

The maximum driving voltage of the actuator 115 can be obtained while operating the actuator 115. That is, referring to FIG. 4B, a driving voltage Vact of the actuator 115 at a near-field light detection level is held or stored as a first driving voltage, and a driving voltage of the actuator 115 when the actuator 15 is raised to an emergency level is held or stored as a second driving voltage Vact′. The emergency level may be defined as a contact level at which the SIL 114 included in the light focusing element 113 and the disk 101 contact each other, or a level near to the contact level. The second driving voltage Vact′ may correspond to the maximum driving voltage kVact of FIGS. 3A, 3B, and 3C. The control module 130 can determine whether the actuator 115 reaches the emergency level by monitoring a gap error signal.

Once the second driving voltage Vact′ is held or stored, the control module 130 raises the actuator 115 until a driving voltage of the actuator 115 becomes the second driving voltage Vact′, and then lowers the actuator 115. When the actuator 115 is lowered, the control module 130 controls the servo module 120 to perform focus pull-in at a point where a driving voltage V of the actuator 115 satisfies Vact<V<Vact′. In FIGS. 4B and 4C, an arbitrary point between the first driving voltage Vact and the second driving voltage Vact′ is determined as a focus pull-in target point. A driving voltage of the actuator 115 may vary linearly as shown in FIG. 4B or exponentially as shown in FIG. 4C.

When focus pull-in is performed as shown in FIGS. 4B and 4C, when the first driving voltage Vact is held or stored, and when the second driving voltage Vact′ is held or stored, the servo module 120 stops the operation of the actuator 115. FIGS. 4A, 4B, and 4C illustrate another example of focus pull-in performed by the near-field optical disk apparatus 100 of FIG. 1, according to another embodiment of the present invention.

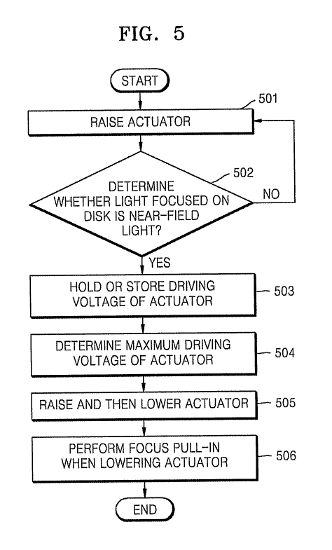

FIG. 5 is a flowchart illustrating a focus pull-in method according to an embodiment of the present invention. The focus pull-in method of FIG. 5 will now be explained with reference to the near-field optical disk apparatus 100 of FIG. 1.

In operation 501, the actuator 115 of the near-field optical disk apparatus 100 is raised. In operation 502, the control module 130 monitors and determines whether light focused on the disk 101 loaded in the near-field optical disk apparatus 100 is near-field light. The monitoring is performed based on a gap error signal produced by the servo module 120. The control module 130 can monitor the voltage level of the gap error signal because the voltage level of the gap error signal is maintained constant when the light focused on the disk 101 is far-field light, but the voltage level of the gap error signal is decreased when the light focused on the disk 101 is near-field light. When the voltage level of the gap error signal is decreased to a near-field light detection level as shown in FIG. 2, the control module 130 determines that the light focused on the disk 101 is near-field light.

If it is determined, in operation 502, that the light focused on the disk 101 is the near-field light, the control module 130 stops the operation of the actuator 115 and holds or stores a driving voltage of the actuator 115 in operation 503.

In operation 504, a maximum driving voltage k×Vact or kVact of the actuator 115 is determined using a preset k and the driving voltage of the actuator 115 held or stored in operation 503. The k is similar to the k illustrated in FIGS. 3A, 3B, and 3C, and the determining of the maximum driving voltage kVact is performed in a similar manner as described above.

Once the maximum driving voltage kVact of the actuator 115 is determined in operation 504, the control module 130, in operation 505, controls the servo module 120 to raise the actuator 115 until a driving voltage of the actuator 115 reaches the maximum driving voltage kVact, and once the driving voltage of the actuator 115 reaches the maximum driving voltage kVact, the control module 130 controls the servo module 120 to lower the actuator 115.

In operation 506, when the actuator 115 is lowered, the control module 130 controls the servo module 120 to perform focus pull-in. That is, when the actuator 115 is lowered, the control module 130 controls the servo module 120 to perform focus pull-in at a point where a driving voltage of the actuator 115 is between the maximum driving voltage kVact and the held or stored driving voltage Vact of the actuator 115. At this point, if a focus pull-in target point is a point at which a driving voltage of the actuator 115 is the held or stored driving voltage Vact as shown in FIGS. 3B and 3C, the control module 130 performs focus pull-in when the actuator 115 is lowered and a driving voltage of the actuator 115 becomes the held or stored driving voltage Vact.

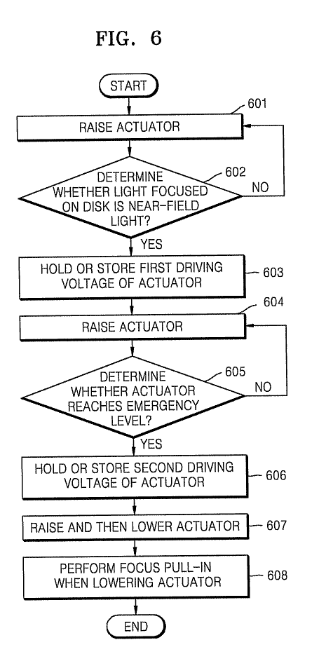

FIG. 6 is a flowchart illustrating a focus pull-in method according to another embodiment of the present invention. The focus pull-in method of FIG. 6 will now be explained with reference to the near-field optical disk apparatus 100 of FIG. 1. The focus pull-in method of FIG. 6 is different from the focus pull-in method of FIG. 5 in that a maximum driving voltage of the actuator 115 is obtained by raising the actuator 115 to an emergency level.

Operations 601 through 603 of FIG. 6 are similar to operations 501 through 503 of FIG. 5 except that a held or stored driving voltage Vact of the actuator 115 is defined as a first driving voltage in operation 603.

In operation 604, the control module 130 controls the servo module 120 to raise the actuator 115 again. In operation 605, the control module 130 checks and determines whether the actuator 115, which is raised, reaches an emergency level. The control module 130 checks and determines whether the actuator 115 reaches the emergency level by monitoring the voltage level of a gap error signal. The emergency level is a contact level at which the SIL 114 of the light focusing element 113 and the disk 101 contact each other, or a level near to the contact level. The control module 130 can check and determine whether the actuator reaches the emergency level based on the monitoring result of the voltage level of the gap error signal since the gap error signal approaches zero (0) volts as the actuator 115 gets closer to the disk 101. The control module 130 may perform the checking using a reference value close to zero (0) volts.

If it is determined in operation 605 that the actuator 115 reaches the emergency level, the control module 130 stops the operation of the actuator 115, and holds or stores a driving voltage of the actuator 115 at this time as a second driving voltage Vact′ in operation 606. The second driving voltage corresponds to the maximum driving voltage kVact of FIG. 5. Accordingly, the second driving voltage Vact′ may be k times the first driving voltage Vact. Here, the k is same as the k illustrated in FIGS. 3A, 3B, and 3C.

In operation 607, the control module 130 raises the actuator 115 until a driving voltage of the actuator 115 reaches the second driving voltage Vact′, and then lowers the actuator 115. However, in operation 607, the control module 130 may not raise the actuator 115 before the lowering thereof as the driving voltage of the actuator 115 may already be equal to the second driving voltage Vact′, in which case the control module 130 need only lower the actuator 115. In operation 608, when the actuator 115 is lowered, the control module 130 performs focus pull-in at a focus pull-in target point satisfying Vact′<V<Vact where a driving voltage of the actuator 115 is between the second driving voltage Vact′ and the first driving voltage Vact.

A program for the focus pull-in method according to the present invention may be embodied as computer readable codes on a computer readable recording medium. The computer readable recording medium is any data storage device that can store data which can be thereafter read by a computer system. Examples of the computer-readable medium include storage media such as magnetic storage media (e.g., read only memories (ROMs), floppy discs, or hard discs), optically readable media (e.g., compact disk-read only memories (CD-ROMs), or digital versatile disks (DVDs)). The computer readable codes may be transmitted over the Internet for recording on a computer readable recording medium. Also, the computer readable recording medium can be dispersively installed in a computer system connected to a wired or wireless network, and stored and executed as a computer readable code in a distributed computing environment.

As described above, the near-field optical disk apparatus according to aspects of the present invention can perform stable focus pull-in by preventing collisions between the SIL and the disk due to overshoot during the focus pull-in.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A focus pull-in method, comprising:
raising an actuator while monitoring and determining whether light focused on a disk is near-field light;
holding or storing a first driving voltage of the actuator if the light focused on the disk is the near-field light;
raising the actuator to determine a maximum driving voltage of the actuator; and
performing focus pull-in while lowering the actuator through an interval in which a driving voltage of the actuator is between the maximum driving voltage and the held or stored first driving voltage.

2. The focus pull-in method of claim 1, wherein the monitoring and determining of whether the light focused on the disk is the near-field light is performed based on a gap error signal.

3. The focus pull-in method of claim 1, further comprising stopping the operation of the actuator, when the holding or storing of the first driving voltage of the actuator is performed.

4. The focus pull-in method of claim 3, wherein the maximum driving voltage is k times the held or stored first driving voltage, and the k is a preset value based on a gap distance between a lens included in a light focusing element moved by the actuator and the disk, and the preset value is further based on driving voltage characteristics of the actuator.

5. The focus pull-in method of claim 3, wherein the determining of the maximum driving voltage of the actuator comprises monitoring a gap error signal and the driving voltage for the actuator, and raising the actuator to an emergency level.

6. The focus pull-in method of claim 5, wherein the emergency level is a level at which a lens included in a light focusing element and the disk nearly contact.

7. The focus pull-in method of claim 6, wherein the emergency level is a contact level at which the lens and the disk are in contact.

8. The focus pull-in method of claim 1, wherein the maximum driving voltage is k times the held or stored driving voltage, and the k is a preset value based on a gap distance between a lens included in a light focusing element moved by the actuator and the disk, and the preset value is further based on driving voltage characteristics of the actuator.

9. The focus pull-in method of claim 1, wherein the raising of the actuator to determine the maximum driving voltage of the actuator comprises:
monitoring a gap error signal and the driving voltage for the actuator while raising the actuator to an emergency level to determine the maximum driving voltage.

10. The focus pull-in method of claim 9, wherein the emergency level is a level at which a lens included in a light focusing element and the disk nearly contact or are in contact.

11. A near-field optical disk apparatus, comprising:
a light focusing element to focus light emitted from a light source on a disk;
an actuator to raise and lower the light focusing element in a direction perpendicular to the disk according to a driving voltage of the actuator;
a light intensity detector to detect the intensity of light returned from the light focusing element;
a servo module to produce a gap error signal and a driving voltage for the actuator according to the intensity of light detected by the light intensity detector, and to provide the driving voltage to the actuator; and
a control module to control the servo module to perform a focus pull-in during lowering the actuator after raising the actuator according to the driving voltage and the gap error signal,
wherein the servo module provides the gap error signal and the driving voltage for the actuator to the control module.

12. The near-field optical disk apparatus of claim 11, wherein the control module:
monitors and determines whether light focused on the disk is near-field light while raising the actuator from a far-field toward the disk;
holds or stores a driving voltage of the actuator if the light focused on the disk is the near-field light;
determines a maximum driving voltage of the actuator when raising the actuator; and
performs the focus pull-in while lowering the actuator through an interval in which the driving voltage of the actuator is between the maximum driving voltage and the held or stored driving voltage.

13. The near-field optical disk apparatus of claim 12, wherein the control module monitors and determines whether the light focused on the disk is near-field light according to the gap error signal.

14. The near-field optical disk apparatus of claim 12, wherein the control module controls the servo module to stop the operation of the actuator when the holding or storing of the driving voltage of the actuator is performed.

15. The near-field optical disk apparatus of claim 14, wherein the maximum driving voltage is k times the held or stored driving voltage, and the k is a predetermined value based on a gap distance between a lens included in the focusing lens moved by the actuator and the disk and driving voltage characteristics of the actuator.

16. The near-field optical disk apparatus of claim 14, wherein the control module monitors the gap error signal and the driving voltage for the actuator, raises the actuator to an emergency level, determines the maximum driving voltage corresponding to the emergency level, and holds or stores the determined maximum driving voltage.

17. The near-field optical disk apparatus of claim 16, wherein the emergency level is a level at which a lens included in the light focusing element and the disk nearly contact or are in contact.

18. A focus pull-in method, comprising:
raising an actuator toward an optical disk from a far-field region to a near-field region;
storing a first driving voltage of the actuator at a point at which the actuator moved from the far-field region to the near-field region;
determining a maximum voltage of the actuator;
lowering the actuator from a level corresponding to the maximum voltage to a level corresponding to a focus pull-in target point.

19. The focus pull-in method of claim 18, wherein the determining the maximum voltage of the actuator comprises:
multiplying the first driving voltage by a predetermined value k, the predetermined value k being dependent upon a gap distance between a lens included in a light focusing element moved by the actuator and the disk and/or the predetermined value k being dependent upon driving voltage characteristics of the actuator.

20. The focus pull-in method of claim 18, wherein the determining the maximum voltage of the actuator comprises:
raising the actuator to an emergency level and determining a voltage of the actuator at the emergency level, the voltage of the actuator at the emergency level being the maximum voltage of the actuator.

21. The focus pull-in method of claim 20, wherein the emergency level is a level at which a lens included in a light focusing element moved by the actuator and the disk nearly contact.

22. The focus pull-in method of claim 20, wherein the emergency level is a level at which a lens included in a light focusing element moved by the actuator and the disk contact.

23. The focus pull-in method of claim 20, wherein the emergency level is a level at which a gap error signal is nearly zero.

24. The focus pull-in method of claim 18, wherein the focus pull-in target point is the first driving voltage of the actuator.

25. The focus pull-in method of claim 18, wherein the focus pull-in target point is between the first driving voltage of the actuator and the maximum voltage of the actuator.
